(19) United States
(12) Patent Application Publication
(10) Pub. No.: US 2003/0225899 A1
(43) Pub. Date: Dec. 4, 2003

(54) Enhancing system performance using a network-based multi-processing technique

(76) Inventor: Walter Vincent Murphy, South San Francisco, CA (US)

Correspondence Address: Walter V. Murphy, 210 Northwood Drive, South San Francisco, CA, 94080, US

(21) Appl. No.: 10/156,456

(22) Filed: May 28, 2002

(51) Int. Cl. G06F 15/16

(52) U.S. Cl. 709/230

(57) ABSTRACT

A system and method is described to utilize a common feature many modern networks are capable of supporting known as ‘multicast’ to distribute data objects to multiple recipients. This invention uses network multicast in a novel way to reduce the quantity of initiating transmissions from a controlling computer. By providing the means to transmit data only once and the means of sending multiple data segments in one data packet, system overhead is greatly reduced. This invention also uses multicasting to distribute processing away from the central initiating computer out to a larger collection of target devices. Finally, this invention also uses grouping of target resources in such a way as to provide increased system concurrency and to reduce the effect of recipient device latencies.

### FIELD OF INVENTION

This invention relates generally to high performance data distribution in a network, for example, LAN (Local Area Network) or WAN (Wide Area Network), in application with distributed computing, computer clusters, distributed storage, storage clusters, computational grids, NAS (Network Attached Storage), SAN (Storage Area Network) and next generation storage architectures.

### BACKGROUND

In the past, when the performance of an overall networked system was lacking, the following techniques have been used to improve overall system performance:

More RAM memory;

Faster CPUs;

Aggregating CPUs on one bus or fabric, also known as SMP or Symmetric Multi-Processing;

Faster disk drives;

Aggregating disk drives as described in various RAID technologies;

Faster network technology;

Aggregating multiple network connections, also known as ‘bonding’ or ‘trunking’;

Aggregating independent computers into clusters.

Although each of these techniques result in improved performance, there is still a higher level of aggregation that can be achieved. These techniques do not fully approach a solution in the context of the overall system. For example, speeding up a network does not help overall system performance if the speed of the controlling CPUs was already creating a bottleneck. Likewise, disk drive performance is likely to be unsatisfactory since a disk drive is a mechanical device. However, if disk drive subsystem performance is already adequate due to, for example, correct application of RAID technology or state-of-the-art disk drives, then network performance could be a significant bottleneck.

### SUMMARY OF THE INVENTION

The present invention is applicable to any form of network media and network protocol. A non-exhaustive list of such network components includes: 100 or 1000 or 10000 Mbps Ethernet, iSCSI, USB, IEEE-1394, Fiber Channel, FDDI, TCP/IP, and ATM.

The present invention relates to a set of network target devices that collectively receive large quantities of data transferred with high network channel utilization. Examples of such network target devices are: graphics rendering machines, numerical simulation machines, supercomputer clusters and storage and backup systems. This invention provides several system improvements, specifically: 1) how to maximize network media utilization; 2) how to minimize network protocol overhead; 3) how to send data to a plurality of target devices, not necessarily uniformly to those target devices, and send said data only once; 4) how to arrange for the processing of data which is derived from the data referred to in the previous item; 5) how to increase the amount of overlapped processing in a cluster of target devices. Under condition of a particular arrangement of system components, a new method is presented. This method sends multiple data segments to multiple network-attached target devices in one transfer instead of one transfer per target device. The result is a higher aggregate throughput within a networked system.

A system constructed in accordance with the principles of this invention is applicable to systems where the network is an integral component of the system and where a plurality of recipient subsystems, also known as target devices within this invention disclosure, participate in processing the received data. Such a system reaches higher performance than traditionally achieved by exploiting overlapped operations in both the network and multiple network nodes simultaneously. This is in contrast to optimization of individual subsystem elements.

This invention features a mechanism for distribution and delegation of application-specific processing from hierarchically higher system components to hierarchically lower processing nodes in a network. This enhances system processing power and scalability since a portion of processing is now moved off the relatively few initiating computers to the relatively many target devices. The method for doing this exploits the inherent potential parallelism of a cluster of target devices by using multiple network connections from the initiating computer. Related data segments of application data are batched together into a larger block and broadcast or multicast to the cluster of network devices which need to receive the aforementioned data segments.

Multicasting is a technique for sending packets of data one time and having them received simultaneously by a pre-designated subset of nodes, usually more than one, on the network without retransmission. In the past, multicasting has been used to send continuous streams of packets to a plurality of network-connected devices. Broadcast is a technique for sending packets of data one time and having them received simultaneously by all nodes on a physically distinct network without retransmission. In this invention, the term ‘polycast transmission’ will be used whenever either the technique of broadcasting or the technique of multicasting could be used.

In a sample application, and in the context of existing technology, a set of separate data items or data segments is sent to a set of separate target devices. The traditional way of sending a data segment to each target device is to send each data segment separately. Each data segment is enclosed in the layers of protocol overhead imposed by the physical media and by the protocol algorithm. Protocol overhead, as a quantitative measurement, is generally not affected by the size of the data content. So overhead, as a percentage of a complete data transmission, goes down as the size of the data payload goes up. Also, it is not unusual for the physical media to have restrictions on packet size and to have and, sometimes require, an interframe gap or dead area between packets. This gap between packets is also a form of overhead in that the gap takes away from the amount of useful data that can be sent through the network channel. This can be seen in the physical layer specification to Ethernet, IEEE 802.3. An object of this invention is to reduce the effect of the overhead of network protocol processing. Additionally, packet or frame preamble and postamble is overhead. The net affects of that overhead is also addressed and potentially reduced by this invention.

Additionally, in the sample application mentioned in the preceding paragraph, there are one or more additional target devices receiving multiple of these data segments. The common method is to send each segment individually or create a specially constructed message containing the several segments for each target device as necessary. This ignores the fact that each segment passes through the sending computer's network interface more than once. This is an inefficient use of that interface and negatively affects total network throughput from the initiating computer device. An object of this invention is to reduce or eliminate sending data segments through a network interface to a plurality of recipient network devices more than once.

In the present invention, a set of separate data segments is combined into one data block. The data blocks contain a plurality of data segments. Said data block is sent to a group of related recipient target devices through a multicast distribution device. The related group of recipient target devices may be referred to as a cluster. Each target device within a cluster receives the same data block and takes from said data block a subset of the block, known as a data segment or multiple data segments, as required. Each target device ignores the data segments not required. The data segments may be of any size and may be of mixed sizes within a single data block. There may be other data in the data block besides the data segment(s). This other data may operate in a control capacity for the system of this invention; for example, but not limited to: the provision of transmission control parameters, logging information, or debugging information. Other data may be present within the data block which has no bearing on the operation of an embodiment of this invention. There is a process or mechanism in the recipient target device which operates to pick out the required data segments at the appropriate time.

The data segments within a data block are required by the union of target devices within a target device cluster. Nevertheless, some target devices receive data segments which may not be useful to those target devices. Those target devices ignore the unneeded data segments. Sending data segments, within a larger data block, to specific target devices, within a target device cluster, that do not necessarily need that data segment, is not harmful of aggregate network throughput. This is due to the fact that any data segments unneeded by a particular target device are needed by a different target device within the same target device cluster and within the same time frame. Furthermore, no data segments get sent more than once, all data segments are being sent in one network protocol transaction in contrast to one transaction per data segment and, within the scope of this system, no other transactions would have taken place within the same time frame to the same target device cluster.

Data blocks do not have any size limitations imposed by the principles of the present invention. There may be implementation specific limitations that are related to limitations imposed by the initiating computer device, target device or network system.

In an embodiment of a system constructed in accordance with the principles of the present invention, data segments sent from the initiating computer device can have the same or different sizes. Also, data segments within a data block can have the same or different sizes as other data segments within the same data block. The collection of data segments within a data block can be viewed as a sequence of structures. A data segment is an element of that structure sequence. There are multiple methods by which the recipient target device can respond to data blocks present on the network. A non-exclusive list of these is:

a) Data segments contain embedded data revealing some identification information. This identification information is sufficiently unique that the recipient target device is able to determine whether the present target device should receive a particular data segment at this time. An advantage to this method is that a data segment can be self-describing. A process in the recipient target device can interpret the self-describing data segments in order to decide which to ignore and which to pass on to some other target device process acting as the immediate consumer of the data segments.

b) Data segments are received based solely upon previously known positional information. This positional information precisely describes where, within a data block, a data segment or set of data segments resides. This positional information is provided to the recipient target device before data blocks are sent to said device. An advantage to this method is that positional information about data segments, which may change infrequently, is not required to be sent in every data block. In some uses of the present invention, this can improve recipient target device efficiency.

c) All data segments within a data block are received by the recipient target device. This may be required in some applications or it may be used as a diagnostic aid.

Consider, for example, a plurality of initiating computer devices sending application-specific data segments to a cluster of target devices over a short period of time. The particular set of target devices constituting a cluster can be static or dynamically determined prior to each transfer from an initiating computer. In most typical applications some amount of time is consumed after reception of a data segment for processing of that data or for carrying out the operation indicated by a message in the data segment. In a non-overlapped system this period of time is wasted as the initiating computer is forced to wait for the processing to complete before the initiating computer could send out the next data segment, even if that segment was being sent to a different target device. In a system implementing the method of the present invention, overlapped operation can be achieved from the point-of-view of the initiating computer due to its ability to send another data block to a target device cluster different than the previous target device cluster even while that initial cluster is collectively processing the previously received data segment. This capability requires a fully reentrant or multi-threaded protocol stack implementation in the initiating computer. The result of this is an enhanced ability of the initiating computer to initiate overlapped operations within the cluster of target devices.

In another embodiment of the present invention, the initiating computer is given multiple connections to a multicast distribution device. Now, even more overlapped operation is achieved by using more than one channel from the initiating computer to the multicast distribution device. In this way, the initiating computer can send a data block to one set of target devices and simultaneously send another data block to a different set of target devices through a different network port connection. This capability also requires a fully reentrant or multi-threaded protocol stack implementation in the initiating computer. The result of this is higher levels of system parallel operation and higher aggregate system throughput.

The present invention also supports a system where some target devices are associated with a plurality of data segments in the data block. For example, although some target devices in the cluster are intended to extract a single data segment from a data block, other target devices in the same cluster are intended to perform their function by examining a plurality of segments from the entire data block as needed. This is done through an application-specific algorithm, which determines what data to examine or use. This scenario demonstrates how broadcasting data segments or multicasting data segments to a target device cluster allows a delegation of processing power combined with a more efficient use of the initiating computer's network connection or connections to achieve a higher aggregate system utilization.

### BRIEF DESCRIPTION OF THE DRAWINGS

Drawing Figures

The accompanying drawings, incorporated in and constituting a part of this specification, illustrate an embodiment of the invention and, together with the description, serve to explain the principles of the invention.

FIG. 1 is a block diagram of an embodiment of a set of items comprising the target device Page 7 of 28 cluster, the multicast distribution device and the initiating computer device.

FIG. 2 is a block diagram of a data block showing a target device, from the same embodiment of FIG. 1, selecting a data segment as that data block comes in from the network connection.

FIG. 3 shows one representative data block, operating within the same embodiment of FIG. 1, being sent through a multicast distribution device to a set of target devices.

FIG. 4 shows a new embodiment where one 4, or more, segment data block is being sent through a multicast distribution device to a set of target devices.

FIG. 5 shows, in a new embodiment, a plurality of target device clusters, which ultimately connect through a single network connection to one initiating computer device.

FIG. 6, when juxtaposed with FIG. 5, shows the logical equivalence of one large multicast distribution device to multiple multicast distribution devices being used to attach a plurality of target device clusters through a single network connection to an initiating computer device.

FIG. 7 shows, in a new embodiment, a plurality of target device clusters connected through a plurality of networked connections to one initiating computer device.

FIG. 8 shows, in a new embodiment, a plurality of target device clusters connected through a plurality of networked connections to a plurality of initiating computer devices.

FIG. 9 shows, in a new embodiment, a plurality of target device clusters, in a target device array, connected through a plurality of networked connections to an initiating computer device.

FIG. 10 shows a flowchart of the method necessary to operate an initiating device constructed in accordance with the principles of the present invention.

FIG. 11 shows a flowchart of the method necessary to operate a target device constructed in accordance with the principles of the present invention.

### DETAILED DESCRIPTION

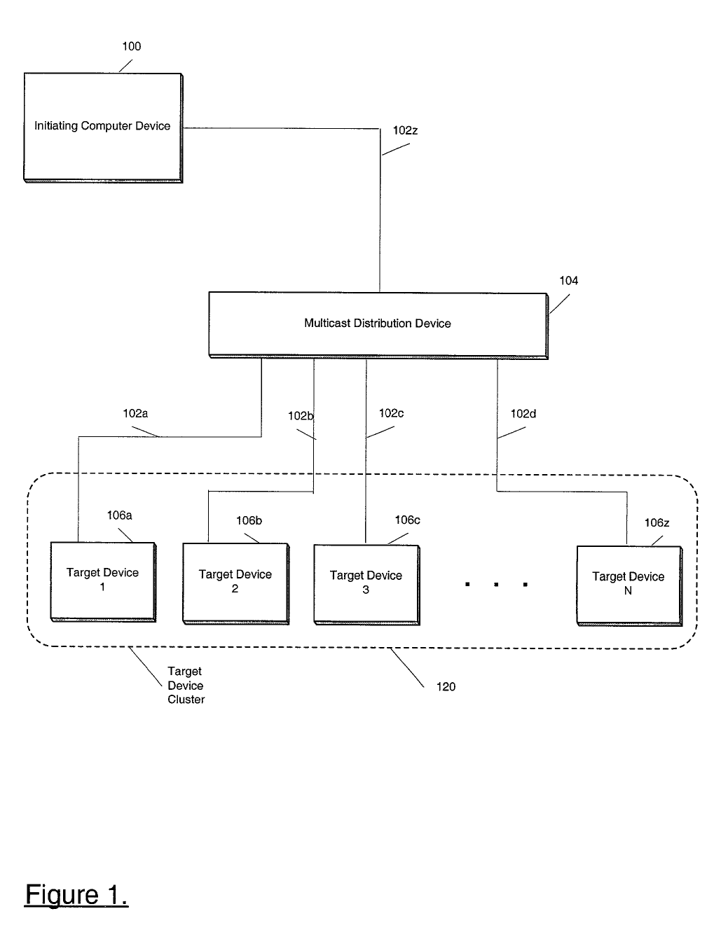

FIG. 1 shows an embodiment of a system constructed in accordance with the principles of the present invention. The system includes an initiating computer device 100, a multicast distribution device 104, a plurality of target devices 106a, 106b, 106c, 106z (generally target device 106), and a plurality of network connections 102a, 102b, 102c, 102d, 102z (generally network connection 102). The minimum quantity of target devices 106 is two. There is no upper limit to the quantity of aforementioned target devices in this invention. There may be a practical restriction in any given implementation due to physical limitations. The multicast distribution device 104 can be a commercially available device known as a network switch.

In FIG. 1, the network connections 102 are point-to-point Ethernet. It is possible to use any arbitrary combination of Ethernet physical media speeds or media types desired among the network connections 102. There can be performance advantages provided by this invention when the connection from the initiating computer device 100 to the multicast distribution device 104 is at a higher speed than the connections 102a, 102b, 102c, and 102d to each of the target devices 106. Particularly in this case, packet buffering in the multicast distribution device 104 enhances the ability of the initiating computer device 100 to overlap its operations. For example; the initiating computer device 100 is connected to the multicast distribution device 104 with 1 gigabit Ethernet. The target devices 106 in the target device cluster 120 are connected with 100 megabit Ethernet. The entire data block from the initiating computer device 100 takes one-tenth as much time to send to the multicast distribution device 104 as the time taken to send said data block to the target device cluster 120. During the other nine-tenths of a data block reception time, the initiating computer device 100 can go on to perform additional computation or distribute additional data blocks if other target device clusters 120 are present in the system. This results in improved network utilization and higher aggregate system throughput.

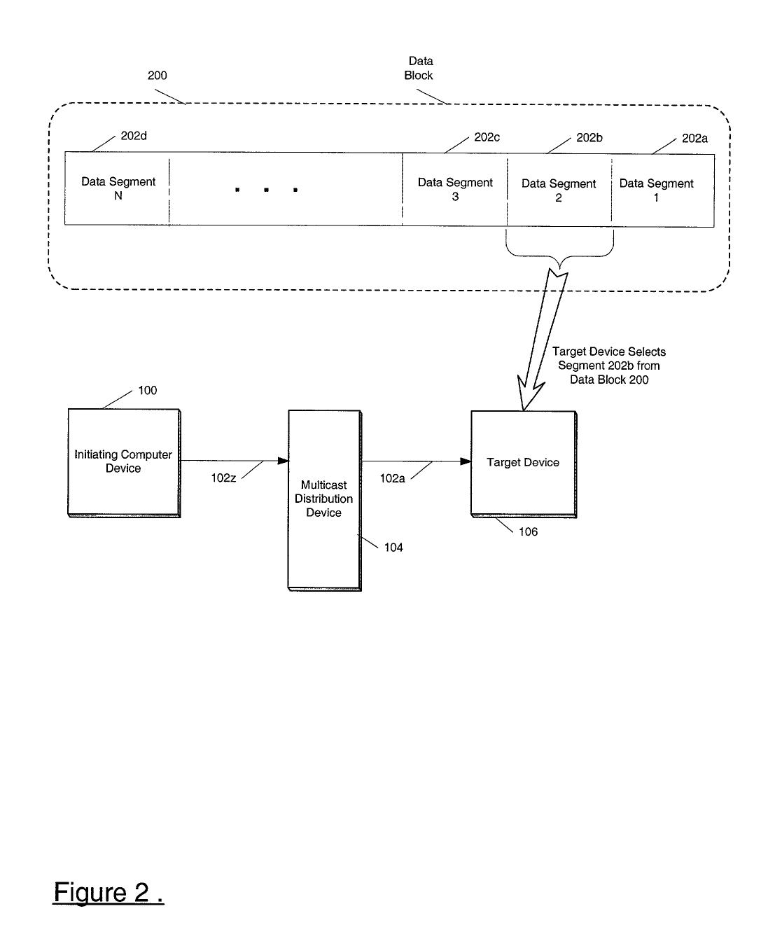

FIG. 2 is comprised of a target device 106, a plurality of network connections 102a, 102z (generally network connection 102), a plurality of data segments 202a, 202b, 202c, 202d (generally data segment 202), and a data block 200. For the sake of example, although any of the data segments 202 could have been selected, assume the target device 106 has a requirement to receive the data segment 202b from the data block 200 to perform its function. The target device 106 has been programmed in advance to recognize the structural composition of the full data block 200. When the data block 200 is sent, by the initiating computer device 100, it is sent to all target devices 106 in a target device cluster 120. The target device 106 waits for the occurrence of the data segment 202b as the data block 200 is received using the network connection 102. As the data segment 202a passes into the target device 106, the data segment 202a is ignored. The data segment 202b is recognized and extracted from the data stream. In this particular example, data segments after the data segment 202b are also ignored because they are not needed by the target device 106. The ignored data segments are received by the target device 106 due to that devices' membership in a target device cluster. It has previously been explained why this does not harm aggregate network throughput.

In order to achieve the most efficient operation possible in the target device 106, the mechanism used to receive and extract the necessary data segment 202b from the data block 200 and ignore the other data segments should be implemented in hardware or in software, designed for this purpose. A non-exhaustive list of possible software approaches include a custom network device driver; a modification to an existing network device driver; a change or enhancement to the network protocol stack; or, special application code designed to interface with the network protocol stack at a low level to facilitate the dropping of the undesired data segments. A non-exhaustive list of possible hardware approaches include the use of a gate array, a hardware state machine, a microprogrammed controller, and fully custom logic. Also, hybrid approaches are possible where customized hardware is combined with custom software.

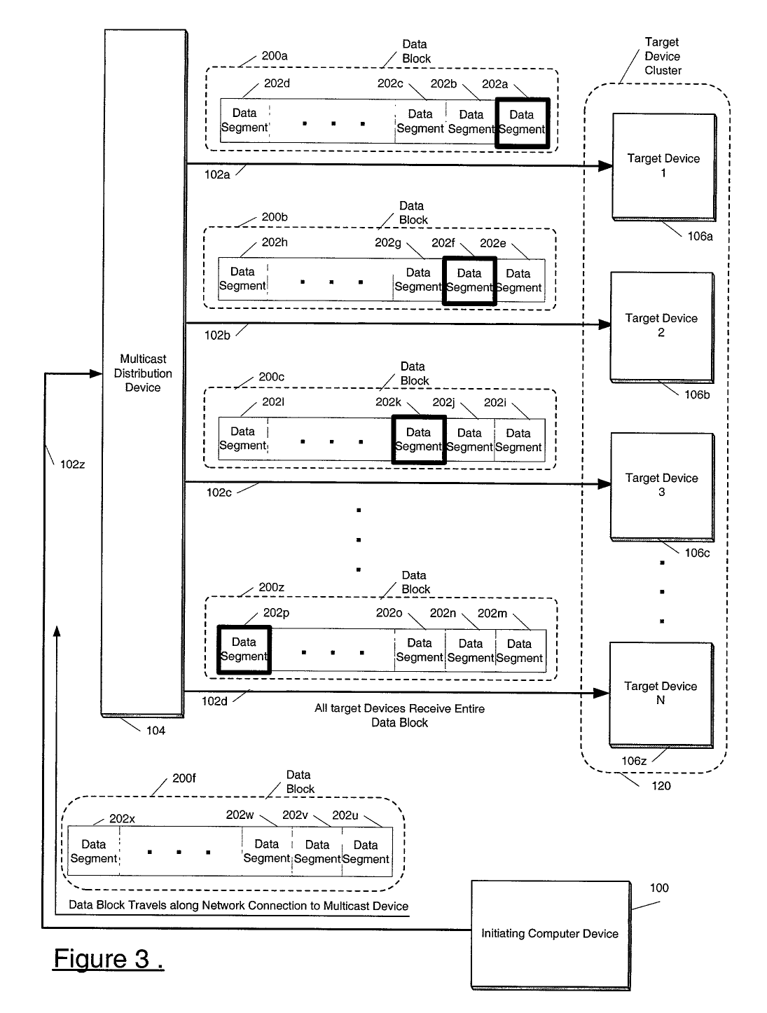

FIG. 3 illustrates the operation of an entire target device cluster 120. The present figure illustrates the initiating computer device 100, a multicast distribution device 104, a plurality of target devices 106a, 106b, 106c and 106z (generally target device 106), a plurality of network connections 102a, 102b, 102c, 102d and 102z (generally network connection 102), a plurality of data block representations 200a, 200b, 200c, 200f and 200z (generally data block 200), and a plurality of data segments 202a, 202b, 202c, 202d, 202e, 202f, 202g, 202h, 202i, 202j, 202k, 202l, 202m, 202n, 202o, 202p, 202u, 202v, 202w, 202x (generally data segment 202). In this figure there is only one data block shown. Data block representations 200a, 200b, 200c, 200f and 200z are the same data block 200 shown in 5 different ways. Therefore, there are only 4 unique data segments shown in the present figure; data segments 202a, 202e, 202i, 202m and 202u are the same data segment; data segments 202b, 202f, 202j, 202n and 202v are the same data segment; data segments 202c, 202g, 202k, 202o and 202w are the same data segment; and data segments 202d, 202h, 202l, 202p and 202x are the same data segments. Software on the initiating computer device 100 wishes to send the individual data segments 202. Data segment 202a, outlined in bold, is received and retained by the target device 106a, the data segment 202f, outlined in bold, is received and retained by the target device 106b, the data segment 202k, outlined in bold, is received and retained by the target device 106c and the data segment 202p, outlined in bold, is received and retained by the target device 106z.

A target device cluster 120 is a logical grouping of target devices 106. This logical grouping is programmed by the particular application and can be reprogrammed, as required, by that application. Technically, a target device cluster 120 may contain zero, one or many target devices 106. Typically, a target device cluster 120 will contain at least 2 target devices 106. Target device 106 quantities of two or more in a target device cluster 120 exhibit the desirable capability of protocol overhead reduction and overlapped operation, when used in accordance with the principles of the present invention. When a target device cluster 120 contains zero or one target devices 106 it may be for a reason such as providing a debugging function, logging system behavior, a temporary condition during system reconfiguration, or any number of additional reasons.

A target device cluster 120 operates in such a way as to receive a flow of data blocks 200 intended by the multicast distribution device 104 for one multicast group or a broadcast group. With most network switch devices currently available commercially, target devices 106 must register with the network multicast distribution device 104 before receiving multicast transmissions of data blocks 200. This is how the multicast distribution device 104 knows which target devices 106 belong to a particular target device cluster 120. Reception of data blocks 200 that are broadcast generally don't require the target device 106 to register with the network multicast distribution device 104. The particular assignment of target device 106 to target device cluster 120 and the quantity and distribution of target device cluster 120 depends upon the needs of the application, the assignment algorithm, and parameters of the implementation such as network speeds, network topology, target device 106 function, target device 106 capability and capacity, and any other parameters which may or may not be unique to the embodiment or to the specific implementation.

At any given time during the operation of a representative system, a set of 2 or more target devices 106 is considered to be a target device cluster 120. In addition, it is expected, although not required, that more than one target device cluster 120 is in existence at any one time during system operation. The particular association of target devices 106 to a target device cluster 120 is permitted to change dynamically during operation of the system.

Target device clusters 120 are formed through the following process. The initiating computer device 100 determines the necessary set of target devices 106 that will be formed into a target device cluster 120. A message is sent to each of these aforementioned target devices 106 informing them of their cluster identifier. With the use of its' cluster identifier, each target device 106 sends a message to the multicast distribution device 104 saying that the target device 106 is joining a particular multicast group. Subsequently, any transmissions sent to that multicast group will be copied to all target devices 106, which are within that group.

In operation, the initiating computer device 100 arranges for the data segments 202 to be packaged in one data block 200. The initiating computer device 100 arranges with each of the target devices 106 to receive the full data block 200. Each target device 106 is also made aware of which data segment 202 said target device 106 will keep and use in any subsequent processing. Although each target device 106 receives an aggregated group of data segments 202, each target device 106 ignores any data segment 202 not needed in subsequent processing.

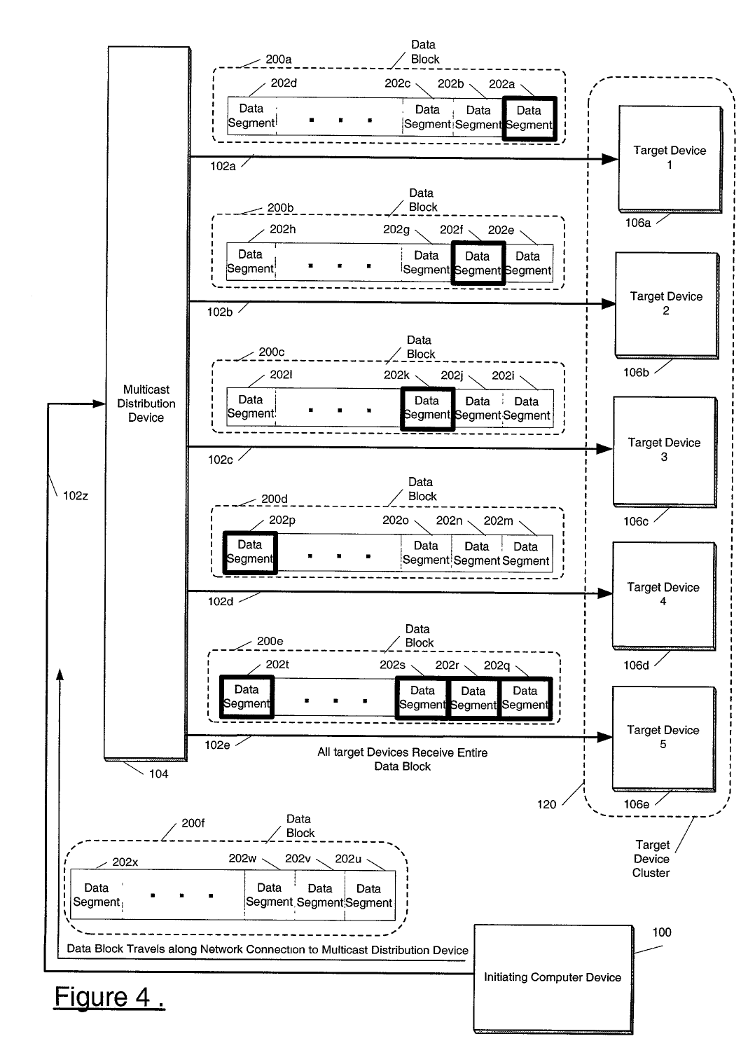

FIG. 4 builds upon the operation disclosed in FIG. 3 by illustrating this systems' capability for distribution and delegation of processing load. FIG. 4 is comprised of an initiating computer device 100, a multicast distribution device 104, a plurality of target devices 106a, 106b, 106c, 106d, 106e (generally target device 106), a target device cluster 120, a plurality of network connections 102a, 102b, 102c, 102d, 102e and 102z (generally network connection 102), a plurality of data block representations 200a, 200b, 200c, 200d, 200e and 200f (generally data block 200), and a plurality of data segments 202a, 202b, 202c, 202d, 202e, 202f, 202g, 202h, 202i, 202j, 202k, 202l, 202m, 202n, 202o, 202p, 202q, 202r, 202s, 202t, 202u, 202v, 202w and 202x (generally data segment 202). In this figure there is only one data block shown. Data block representations 200a, 200b, 200c, 200d, 200e and 200f are the same data block 200 shown in 6 different ways. Therefore, there are only 4 unique data segments shown in the present figure; data segments 202a, 202e, 202i, 202m, 202q and 202u are the same data segment; data segments 202b, 202f, 202j, 202n, 202r and 202v are the same data segment; data segments 202c, 202g, 202k, 202o, 202s and 202w are the same data segment; and data segments 202d, 202h, 202l, 202p, 202t and 202x are the same data segments.

A process on the initiating computer device 100 sends the data block 200 including the 4 data segments 202u, 202v, 202w and 202x. These aforementioned data segments are intended to be received by the target devices 106a, 106b, 106c, and 106d, respectively. Additionally, the target device 106e is tasked to receive the 4 data segments 202q, 202r, 202s and 202t and execute some application-defined algorithm upon those 4 data segments. It is to be noted that, traditionally, the initiating computer device 100 either has sent some data block containing the union of those 4 data segments to the target device 106e for the processing of the algorithm in a separate transfer on the network, or the algorithm processing has previously been executed on the initiating computer device 100 and the resulting data sent to the target device 106e in a separate transfer on the network. In this invention, each of the 4 data segments 202a, 202f, 202k and 202p are picked up by their corresponding target devices 106a, 106b, 106c and 106d and the full set of 4 data segments 202q, 202r, 202s and 202t are picked up by the target device 106e without requiring a separate network transfer. This method provides a degree of overall system processing concurrency and accounts for the aforementioned increased aggregate system bandwidth.

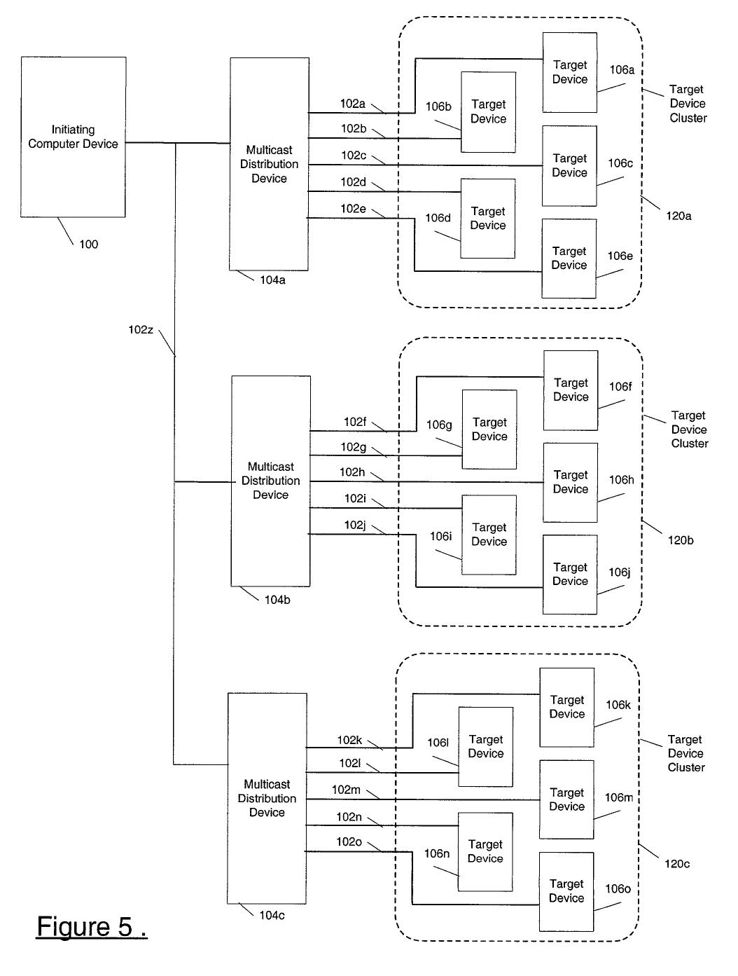

FIG. 5 shows another level of system processing concurrency. FIG. 5 is comprised of an initiating computer device 100, a plurality of multicast distribution devices 104a, 104b and 104c (generally multicast distribution device 104), a plurality of target devices 106a, 106b, 106c, 106d, 106e, 106f, 106g, 106h, 106i, 106j, 106k, 106l, 106m, 106n and 106o (generally target device 106), a plurality of target device clusters 120a, 120b and 120c (generally target device cluster 120) and a plurality of network connections 102a, 102b, 102c, 102d, 102e, 102f, 102g, 102h, 102i, 102j, 102k, 102l, 102m, 102n, 102o and 102z (generally network connection 102). The initiating computer device 100 now has access to the plurality of target device clusters 120. The initiating computer device 100 can send data blocks out to a particular target device cluster 120 and immediately send another data block out to a different target device cluster 120. This takes place even before the previous target device cluster 120 has completed acquiring a data block. This quick succession of data blocks from the initiating computer device 100 can continue, with successful overlap of operations being even more useful in implementations with larger quantities of target device clusters 120. Thus, the system builds upon the overall system processing concurrency previously described and accrues more aggregate system bandwidth.

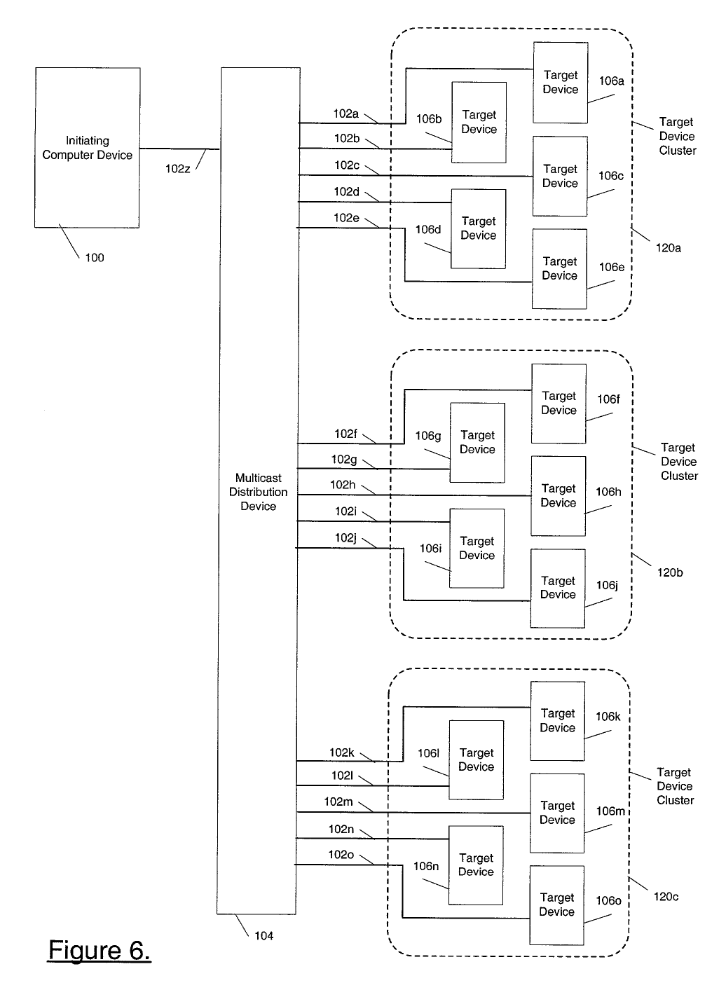

FIG. 6 is comprised of an initiating computer device 100, a multicast distribution device 104, a plurality of target devices 106a, 106b, 106c, 106d, 106e, 106f, 106g, 106h, 106i, 106j, 106k, 106l, 106m, 106n and 106o (generally target device 106), a plurality of target device clusters 120a, 120b and 120c (generally target device cluster 120), and a plurality of network connections 102a, 102b, 102c, 102d, 102e, 102f, 102g, 102h, 102i, 102j, 102k, 102l, 102m, 102n, 102o and 102z (generally network connection 102). FIG. 6 illustrates that there is no requirement to have a physically separate multicast distribution device 104 for each separate target device cluster 120. Target devices can be connected to the multicast distribution device(s) 104 in any way that is pertinent to the particular installation. This results in convenient installation, reconfiguration and maintenance of the system.

An organizational process occurring at a level above target devices 106 and target device clusters 120 formulates a grouping of target devices 106 which become known as a target device cluster 120. This formulation is done within the initiating computer device 100 or some other device which communicates to inform the initiating computer device 100 of the grouping or composition of target devices 106 within the target device cluster 120. Target devices 106 in the target device cluster 120 do not need to be aware of any other target devices 106, whether within their own target device cluster 120 or any others. A target device cluster 120 grouping is potentially a dynamic association. Said grouping may change anytime the initiating computer device 100 determines to make the change. This may happen due to requirements imposed by the particular application making use of the overall system. The specific participation of target devices in said group can be: maintained as a list; algorithmically determined; recalled from some form of script or historical data; or, created by any other means.

Nothing prevents the composition of target device clusters 120 from overlapping. In other words, some target devices 106 in a particular target device cluster 120 may also share membership in a different target device cluster 120. This is conceptually similar to the idea of overlapping sets in a Venn diagram. In some applications of this invention, it may be most natural to not have any overlap among target device clusters 120. In other applications, overlap may be beneficial.

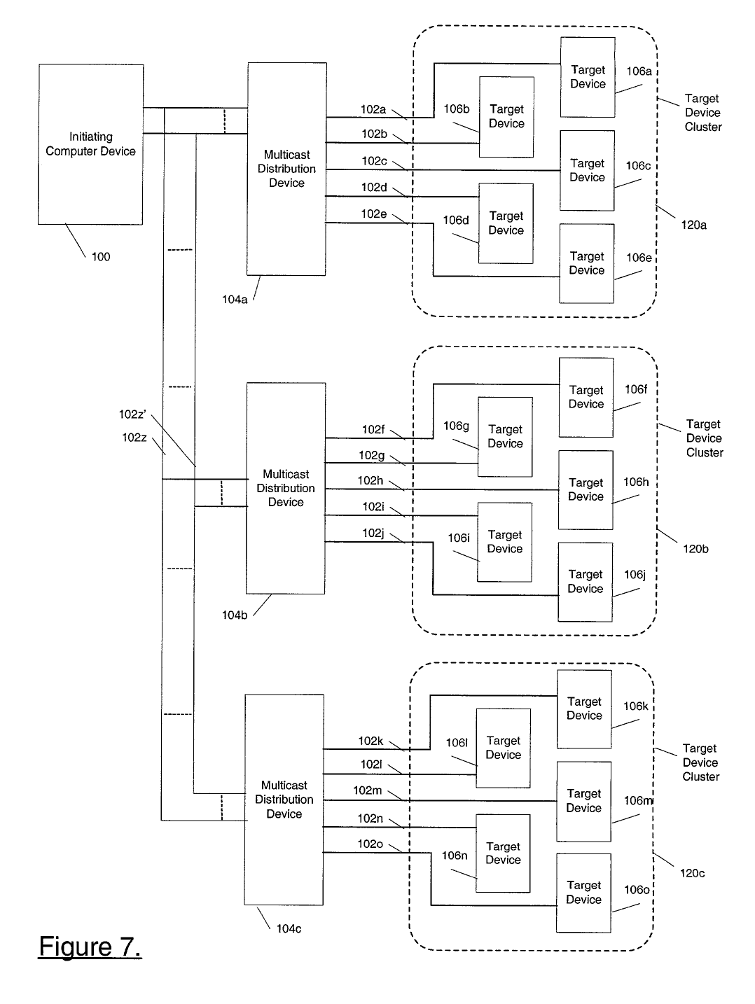

FIG. 7 is comprised of an initiating computer device 100, a plurality of multicast distribution devices 104a, 104b and 104c (generally multicast distribution device 104), a plurality of target devices 106a, 106b, 106c, 106d, 106e, 106f, 106g, 106h, 106i, 106j, 106k, 106l, 106m, 106n and 106o (generally target device 106), a plurality of target device clusters 120a, 120b and 120c (generally target device cluster 120), and a plurality of network connections 102a, 102b, 102c, 102d, 102e, 102f, 102g, 102h, 102i, 102j, 102k, 102l, 102m, 102n, 102o, 102z and 102z′ (generally network connection 102). FIG. 7 shows an embodiment of this invention where the initiating computer device 100 is able to achieve even higher degrees of overlapped operation among the target device clusters 120. This is due to the ability of the initiating computer device 100 to simultaneously send out data blocks to any two target device clusters 120, or more. The initiating computer device 100 does this by concurrently utilizing its plurality of network connections 102z and 102z′. Furthermore, the initiating computer device 100 could achieve even more overlapped operation by having more network connections 102 connecting itself to the multicast distribution device(s) 104. The useful upper limit for the quantity of simultaneous network connections 102 from the initiating computer device 100 to the multicast distribution device(s) 104 is the same as the maximum number of target device clusters 120 to ever be configured in a system. With this embodiment, the system provides a high level of overall system processing concurrency and provides an efficient use of aggregate system bandwidth.

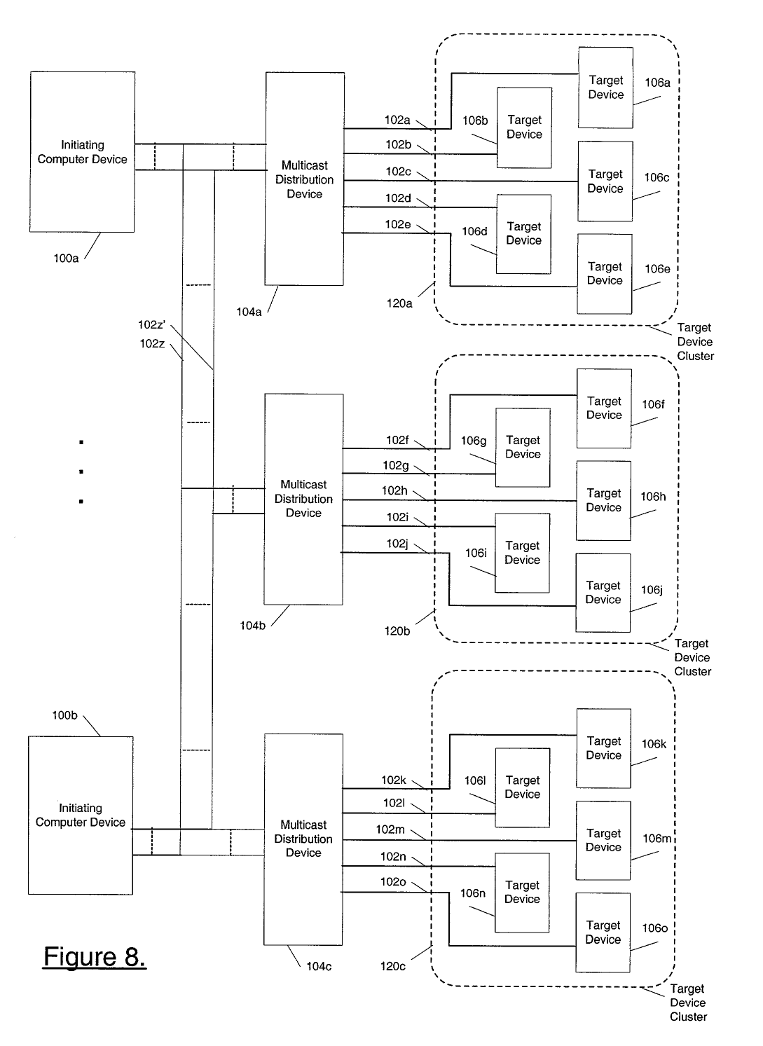

FIG. 8 is comprised of a plurality of initiating computer devices 100a, 100b (generally initiating computer device 100), a plurality of multicast distribution devices 104a, 104b and 104c (generally multicast distribution device 104), a plurality of target devices 106a, 106b, 106c, 106d, 106e, 106f, 106g, 106h, 106i, 106j, 106k, 106l, 106m, 106n and 106o (generally target device 106), a plurality of target device clusters 120a, 120b and 120c (generally target device cluster 120), and a plurality of network connections 102a, 102b, 102c, 102d, 102e, 102f, 102g, 102h, 102i, 102j, 102k, 102l, 102m, 102n, 102o, 102z and 102z′ (generally network connection 102). FIG. 8 shows this invention is not restricted to supporting one initiating computer device 100. In a system with a large quantity of target devices or target device clusters, it is possible that just one initiating computer device 100a could not productively use large quantities of the target devices within the target device clusters 120 during the same time frame. This would be due to the initiating computer device becoming overloaded with the transmission of data blocks. Therefore, multiple initiating computer devices 100a and 100b can use the network bandwidth of the system simultaneously thereby achieving higher overall system utilization. This higher overall system utilization is particularly effective when multiple initiating computer devices 100 are accessing non-overlapping subsets of target device clusters 120.

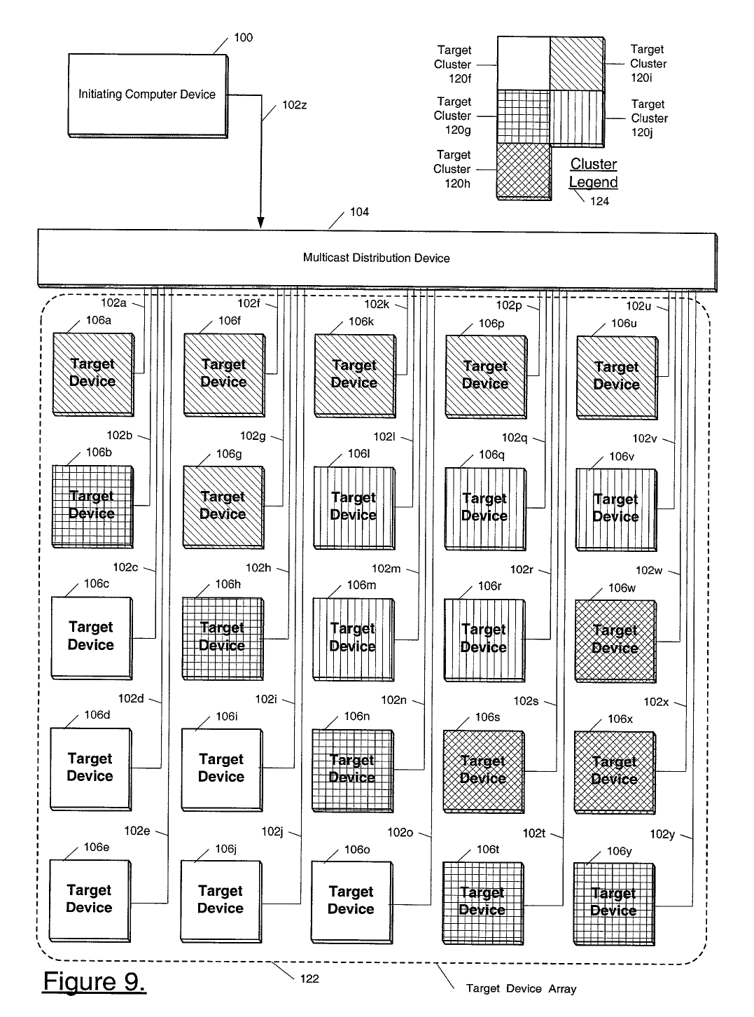

FIG. 9 is comprised of an initiating computer device 100, a multicast distribution device 104, an array of target devices known as target device array 122, consisting of a plurality of target devices 106a, 106b, 106c, 106d, 106e, 106f, 106g, 106h, 106i, 106j, 106k, 106l, 106m, 106n, 106o, 106p, 106q, 106r, 106s, 106t, 106u, 106v, 106w, 106x and 106y (generally target device 106), a cluster legend 124, a sample grouping of target devices 106 into target clusters 120f, 120g, 102h, 120i and 120j (generally target cluster 120) and a plurality of network connections 102a, 102b, 102c, 102d, 102e, 102f, 102g, 102h, 102i, 102j, 102k, 102l, 102m, 102n, 102o, 102p, 102q, 102r, 102s, 102t, 102u, 102v, 102w, 102x, 102y (generally network connection 102). The phrase ‘target device array’ can be considered to mean the general inventory of target devices 106 connected to the plurality of multicast distribution devices 104 through network connections 102. The present figure shows an embodiment where the multicast distribution device 104 is connected to the target device array 122, which contains 25 target devices 106. This particular quantity is used only for the purpose of illustration.

A target device array 122 could have any quantity of target devices 106, constrained only by practical limitations. The cluster legend 124 identifies 5 sets of target device clusters 120 based on the graphical fill pattern in each of the boxes shown. Any assignment of target device 106 to target device cluster 120 within the target device array 122 is possible. This aforementioned assignment is a function of the implementation and may change under control of the system or any personnel directly or indirectly managing the target device array 122. There is no restriction to the way target devices 106 in the target device array 122 are organized into target device clusters 120. Target devices 106 within a target device cluster 120 do not need to be in physical proximity. However, said target devices 106 connect physically to the same multicast distribution device 104 or they connect through some sort of network-based logical channel to the same multicast distribution device 104.

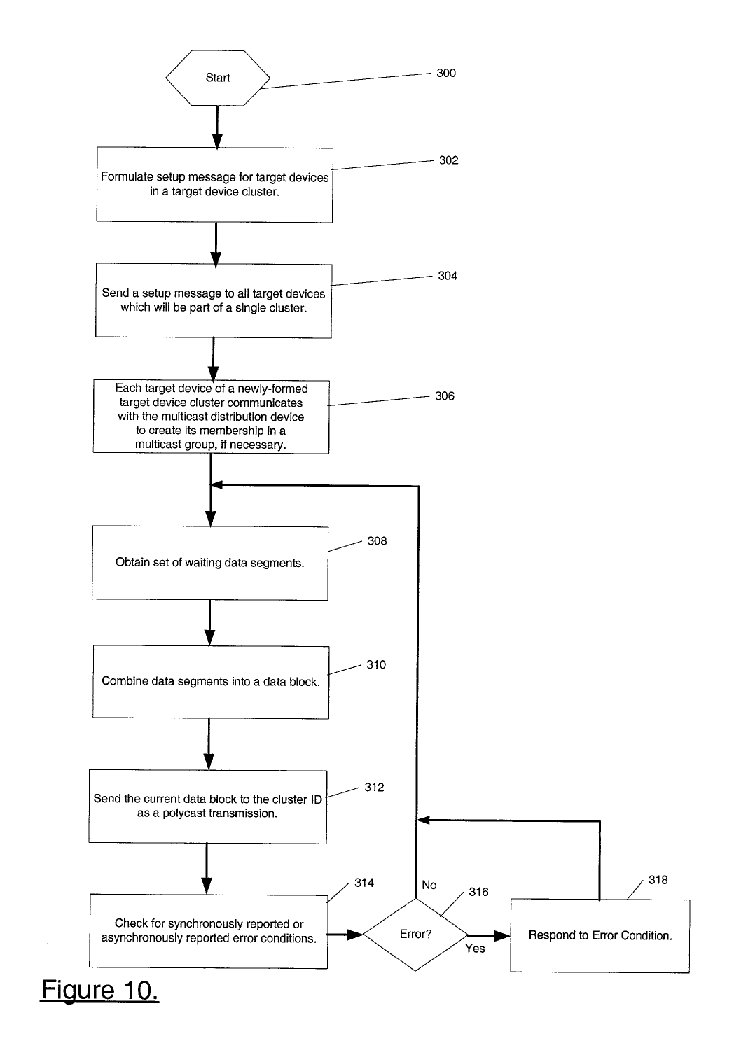

FIG. 10 shows an embodiment of a process for operating an initiating computer device 100 constructed in accordance with the principles of the present invention. Step 300 represents the mode of the initiating computer device 100 after its startup. In step 302, the initiating computer device 100 formulates a setup message to be sent to all target devices 106 in a target device cluster 120. Then, in step 304, this setup message is sent to all target devices 106 which will be part of a particular target device cluster 120. This setup message informs a target device 106 it is joining a target device cluster 120. Each target device 106 of a newly-formed target device cluster 120 communicates (step 306) with the multicast distribution device 104 to create its membership in a multicast group. Now, the initiating computer device 100 is ready to send data blocks 200 to target device clusters 120. The initiating computer device 100 obtains a set of waiting data segments 202 (step 308) from any mechanism provided by said initiating computer device 100. Those data segments 202 are combined into a single data block 200 in step 310. Then, the aforementioned data block 200 is sent, in step 312, to the previously identified target device cluster 120 as a polycast transmission. After completion of the polycast transmission, the initiating computer device 100 should check for error conditions (step 314) being synchronously reported or asynchronously reported from any target devices 106 within the target device cluster 120. If there is an error (step 316), respond to that error (step 318). Response to an error can be anything appropriate to the target devices 106, target device cluster 120, the initiating computer device 100 or the higher-level application residing in any of these devices or related devices. After response to any error, or if no error occurred, return to the point (step 308) where the initiating computer device 100 is ready to send data blocks 200 to target device clusters 120. These polycast transmissions, in step 312, continue to occur as long as there are data blocks 200 to be sent and the initiating computer device 100 continues to run the process described in this flowchart of FIG. 10.

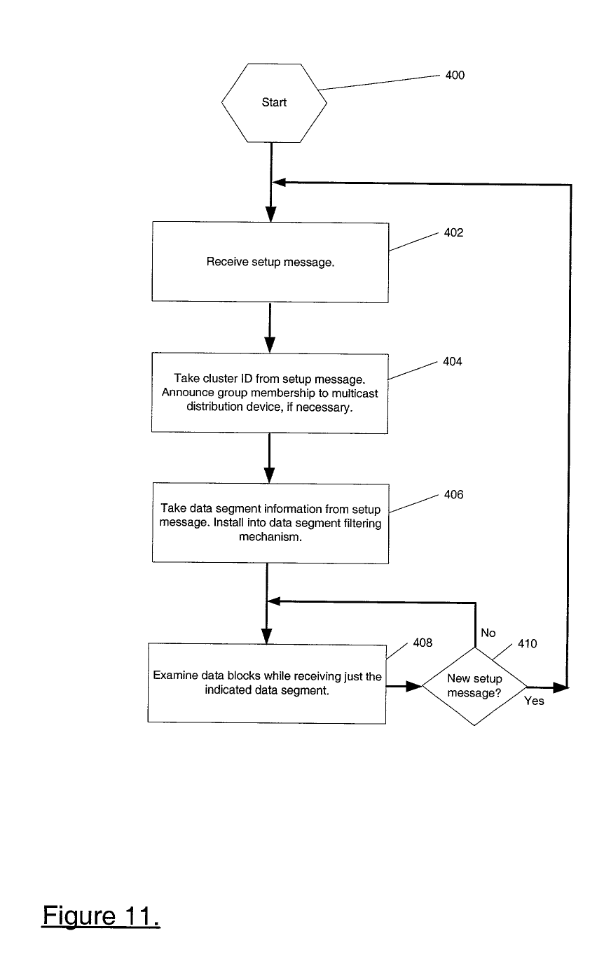

FIG. 11 shows an embodiment of a process for operating a target device 106 constructed in accordance with the principles of the present invention. Step 400 represents the mode of the target device 106 after its startup. In step 402, the target device 106 receives its setup message. This setup message provides the target device 106 identification information and thereby the polycast transmission group membership. This group membership identity is sent, by the target device 106 in step 404, to multicast distribution device 104 so that it will now forward polycast transmission data, intended for the target device cluster 120 of which this target device 106 is a member. Additionally, the target device 106 takes data segment 202 information from the setup message and applies it, in step 406, to its data segment 202 filtering mechanism. This allows the target device 106 to take in just the necessary data segment 202 portion needed by said target device 106 while observing a data block 200 transmission. The target device 106 is now in a mode where it is accepting data segments 202 (step 408) intended just for this target device 106. If a new setup message is sent to this target device 106, the target device 106 returns to the above point (step 402) where the new setup message is to be received. As long as a new setup message is not received, the target device 106 process continuously returns to the point (step 408) where the target device 106 is in a mode accepting data segments 202 intended just for this target device 106. This continues indefinitely, as long as there are data blocks 200 to be received and the target device 106 continues to run the process described in this flowchart of FIG. 11.

To illustrate the principles of this invention, a description is provided below which details how one might use this system and method with present day network devices. For the sake of illustration, this example assumes the use of industry standard Ethernet media in a traditional point-to-point star topology. The multicast distribution device 104 can be a commercial device such as a ‘network switch’ provided the switch supports the multicast standard in use by the other system devices; i.e.: target device and initiating computer device. An example of such a standard is IGMP, the Internet Group Management Protocol (Internet Engineering Task Force, RFC No. 2236).

An implementation of this invention can be seen while referencing FIG. 6. Assume an implementation where the initiating computer device 100 is a common, state-of-the-art workstation, for example, a HP model Netserver e200. The e200 has an extra Ethernet network card added to it for dedicated connection to the rest of the system of this invention. The hardware of a target device 106 could be built or prototyped with an off-the-shelf computer. It could also be custom designed as a dedicated embedded system. That is, a device, containing computer elements, built to have only one function. The function would be appropriate to the intended overall application. A good example would be a compute engine in a grid computer cluster. The target device, in that case, would contain these major elements: CPU, RAM, and Ethernet port. Such a target device could be made small and with a physical design which allows convenient stacking with a large quantity of other target devices.

Multicast distribution devices 104 can be connected to a plurality of target device clusters 120. It would be natural and convenient, given implementations based on modern network products, to use a network switch as a multicast distribution device 104 which had the ability to make 48 network connections 102 and thereby, as a non-limiting example, connect to 4 target device clusters 120 each of which contains 11 target devices 106. Such a multicast distribution device 104 is an HP procurve Ethernet switch.

A target device cluster 120 may be connected to, or span, more than one multicast distribution device 104. An example of such a configuration would be one target device cluster 120, containing 13 target devices 106, which make network connections 102 to two 8-port network switches functioning as a multicast distribution device 104. In this particular example, the two 8-port network switches would be connected together, most likely utilizing spare network ports, so they provide similar functionality to using one larger network switch.

In a second example, the target device is similar to the previous example with the addition of some quantity of disk storage. In this case, the target device would be considered to be a storage node. A target device cluster 120 would be called a storage cluster. A logical use for a single storage cluster would be the sub-system upon which a RAID set is implemented, let's assume RAID4 for this example. The discussion of RAID4 is exemplary, other configurations can be used.

When the workstation sends out a write command for a large block of data, that block is formatted into a data block conformant with the principles of the present invention. For the sake of this example refer to the target devices from FIG. 6 known as 106f, 106g, 106h, 106i and 106j. These target devices make up target device cluster 120b. For this example, target device cluster 120b is also known as the ‘RAID SET B’. Before beginning operation the workstation informs the 5 aforementioned target devices of their membership within target device cluster 120b. Therefore, these target devices arrange, within their internal systems, to receive any blocks placed on the network and intended for that cluster or RAID SET B. Let's further assume, in keeping with the tenets of RAID4, the RAID parity block is intended to go to target device 106j. Assume a data segment size of 512 bytes and a data block containing 4 data segments. When the workstation sends off a data block, said data block is polycast transmitted to the group which represents target device cluster 120b or RAID SET B. The transmitted data block not only contains the raw data, it also contains enough other information that RAID SET B is able to derive where the data segments are to be stored. As the data block is received by all 5 target devices, target device 106j receives all 4 data segments and calculates a running XOR, within its device driver, as the bytes come in. Although 2048 bytes are received by target device 106j, only the derived data, the 512 bytes of XOR result are passed further into the target device from its device driver. The other 4 target devices each receive a different data segment depending upon its identity within the RAID set. Each stores its data segment into a block of storage in its disk drive.

In the example usage of the previous paragraph, it can be seen that many distributed operations were performed by the 5 target devices but only 1 network transaction, and its incumbent protocol overhead, were incurred. A more traditional implementation would have used separate network transactions for each of the 512-byte data blocks and would have calculated the parity block in the workstation. This would have incurred 5 network transactions, the delays among them, and the workstation burden to calculate the parity block. Thus, the approach of this present invention lowers protocol overhead, permits multiple data transmissions in a more compact time frame and improves the ability to delegate processing out of the workstation to a helper processing device.

One skilled in the arts of networking and cluster computing or grid computing will appreciate that the present invention can be practiced by other than the described embodiments, which are presented for purposes of illustration and not of limitation, and the present invention is limited only by the claims which follow.

Modifications and variations of the present invention are possible in light of the above disclosure. These modifications may include the use of alternate and concurrent LAN technologies or other logical or physical data connections to interconnect the initiating computer with the target device(s). Finally, it should be recognized that the mechanisms of the present invention are not limited to inter-operability among the products of a single vendor, but may be implemented independent of the specific hardware and software executed by any particular component in the present invention. Accordingly, it is to be understood that, within the scope of the appended claims, the present invention may be practiced otherwise than as specifically described herein.

1. A system for distributing data over a network to a plurality of target devices, the system comprising:
a computer system in communication with a target cluster over a network, the target cluster being a logical grouping of a plurality of target devices, the computer system preparing a data block for a polycast transmission over the network for delivery to each target device in the target cluster, the data block including a plurality of data segments that are targeted to different target devices in the target cluster.

2. The system of claim 1, wherein the polycast transmission is a multicast transmission.

3. The system of claim 1, wherein the polycast transmission is a broadcast transmission.

4. The system of claim 1, further comprising the plurality of target devices, each target device i) receiving a copy of the data block over the network, ii) extracting from the copy of the data block each data segment that is targeted to that target device as that data segment is received over the network, and, iii) after extracting each data segment that is targeted to that target device, disregarding each data segment in the copy of the data block that is received thereafter.

5. The system of claim 1, wherein the target cluster is a first target cluster and the data block is a first data block, and further comprising:
a distribution device in communication with the computer system over a network connection and with the first target cluster and with a second target cluster associated with a different plurality of target devices, the distribution device receiving the first data block and a second data block from the computer system and transmitting a copy of the first data block to each of the target devices associated with the first target cluster and a copy of the second data block to each of the target devices associated with the second target cluster.

6. The system of claim 5, wherein the distribution device transmits the copy of the second data block to each of the target devices associated with the second target cluster while the target devices associated with the first target cluster are processing the first data block.

7. The system of claim 5, wherein the associations between the target devices and target clusters are dynamically reprogrammable.

8. The system of claim 1, further comprising a distribution device in communication with the computer system over a plurality of separate network connections.

9. The system of claim 8, wherein the data block is a first data block, and the target cluster is a first target cluster, and the distribution device is in communication with the first target cluster and a second target cluster associated with a different plurality of target devices, the computer system transmits the first data block in a polycast transmission to the distribution device over a first one of the plurality of network connections for delivery to each of the target devices associated with the first target cluster and, while the distribution device processes the first data block, transmits a second data block in a polycast transmission to the distribution device over a second one of the plurality of network connections for delivery to each of the target devices associated with the second target cluster.

10. The system of claim 1, further comprising a plurality of distribution devices in communication with the computer system over a plurality of network connections.

11. The system of claim 10, wherein the data block is a first data block, and the target cluster is a first target cluster, and a first one of the distribution devices is in communication with the first target cluster and a second one of the distribution devices is in communication with a second target cluster associated with a different plurality of target devices, the computer system transmitting the first data block in a polycast transmission to the first one of the distribution devices over a first one of the plurality of network connections for delivery to each of the target devices associated with the first target cluster and, while the first one of the distribution devices processes the first data block, transmitting a second data block in a polycast transmission to the second one of the distribution devices over a second one of the plurality of network connections for delivery to each of the target devices associated with the second target cluster.

12. The system of claim 10, wherein the target cluster is a first target cluster, and further comprising a second target cluster associated with a different plurality of target devices, each of the distribution devices being in communication with at least one of the target clusters.

13. The system of claim 12, wherein the data block is a first data block, a first one of the distribution devices transmitting the first data block to each of the target devices associated with the first target cluster, and, while the first one of the distribution devices transmits the first data block, a second one of the distribution devices transmits a second data block to each of the target devices associated with the second target cluster.

14. The system of claim 1, wherein the computer system is a first computer system, and further comprising a second computer system and a plurality of distribution devices, each computer system being in communication with each distribution device.

15. The system of claim 14, wherein the data block is a first data block, the first computer system transmitting the first data block to a first one of the distribution devices, and, while the first computer system transmits the first data block, the second computer transmitting a second data block to a second one of the distribution devices.

16. The system of claim 15, wherein the first one and the second one of the distribution devices are the same distribution device.

17. The system of claim 15, wherein the first one and the second one of the distribution devices are different distribution devices.

18. The system of claim 1, wherein a first one of the data segments in the data block is targeted to a first one of the target devices only and a second one of the data segments in the data block is targeted to a second one of the target devices only.

19. The system of claim 1, wherein each of the data segments in the data block is targeted to a particular one of the target devices in the target cluster and to fewer than all of the other target devices in the target cluster.

20. The system of claim 1, wherein each of the data segments in the data block is targeted to fewer than all of the target devices in the target cluster.

21. A system for distributing data over a network, the system comprising:
means for associating a plurality of target devices in the network with a target cluster;
means for aggregating a plurality of data segments into a data block, the data segments being targeted to different target devices in the target cluster, each data segment being targeted to at least one of the target devices in the target cluster; and
means for transmitting the data block in a polycast transmission to the target cluster over the network for delivery to each of the target devices associated with the target cluster.

22. A method for distributing data over a network, the method comprising:
associating a plurality of target devices in the network with a target cluster;
aggregating a plurality of data segments into a data block, the data segments being targeted to different target devices in the target cluster; and
transmitting the data block in a polycast transmission to the target cluster over the network for delivery to each of the target devices associated with the target cluster.

23. The method of claim 22, further comprising distributing a copy of the data block to each target device in the target cluster.

24. The method of claim 22, further comprising notifying each target device that the target device is a member of the target cluster.

25. The method of claim 22, further comprising extracting from a copy of the data block, by each target device, each data segment that is targeted to that target device as that data segment is received by that target device over the network, and, after extracting each data segment that is targeted to that target device, disregarding each data segment in the copy of the data block that is received thereafter.

26. The method of claim 22, further comprising transmitting information to each target device in the target cluster, the information operating to identify to each target device where in a copy of the data block that target device can locate each data segment targeted to that target device.

27. The method of claim 26, wherein the information is positional information identifying a position in the data block.

28. The method of claim 26, wherein the information is a label.

29. The method of claim 26, wherein the step of transmitting information occurs before the step of transmitting the data block.

30. The method of claim 22, further comprising performing a calculation using the content of the data segments as each data segment is received over the network.

31. The method of claim 22, wherein the data block is a first data block and the target cluster is a first target cluster, and further comprising:
transmitting a copy of the first data block to each of the target devices associated with the first target cluster; and
transmitting a copy of a second data block to each target device associated with a second target cluster while the target devices of the first target cluster are processing the copies of the first data block.

32. The method of claim 22, wherein the data block is a first data block and the target cluster is a first target cluster, and further comprising:
transmitting the first data block in a polycast transmission to a first distribution device over a first network connection for delivery to each of the target devices associated with the first target cluster; and
while the first distribution device processes the first data block, transmitting a second data block in a polycast transmission to a second distribution device over a second network connection for delivery to each target device associated with a second target cluster.

33. The method of claim 32, wherein the first and the second distribution devices are the same distribution device.
